(19) United States
(12) Patent Application Publication
(10) Pub. No.: US 2026/0196134 A1
(43) Pub. Date: Jul. 9, 2026

(54) INFORMATION PROCESSING APPARATUS, INFORMATION PROCESSING SYSTEM, INFORMATION PROCESSING METHOD, AND NON-TRANSITORY COMPUTER-READABLE MEDIUM

(71) Applicant: NEC Corporation, Tokyo (JP)

(72) Inventor: Yoshihiro MISHIMA, Tokyo (JP)

(73) Assignee: NEC Corporation, Tokyo (JP)

(21) Appl. No.: 19/133,362

(22) PCT Filed: Dec. 7, 2022
(86) PCT No.: PCT/JP2022/045051

§ 371 Date: May 28, 2025

(51) Int. Cl. G08G 1/16; G06V 40/10

(52) U.S. Cl. CPC G08G 1/164; G06V 40/103

(57) ABSTRACT

An object is to provide an information processing apparatus capable of appropriately monitoring a vehicle in accordance with a situation of a monitoring person. An information processing apparatus (100) according to the present disclosure includes: acquisition unit (101) for acquiring vehicle situation information about a situation of a vehicle that is a monitoring target; detection unit (102) for detecting an attention-needed state that needs attention in monitoring a vehicle, based on the vehicle situation information; estimation unit (103) for estimating a characteristic of a monitoring person, based on an image obtained by image-capturing the monitoring person; and output control unit (104) for controlling an output of a warning to the monitoring person, based on the characteristic that has been estimated.

### TECHNICAL FIELD

The present disclosure relates to an information processing apparatus, an information processing system, an information processing method, and a non-transitory computer-readable medium.

### BACKGROUND ART

There is a known technique of remotely monitoring a vehicle in a monitoring center using images obtained by image-capturing the inside and outside of the vehicle, position information of the vehicle, and the like. For example, the monitoring center includes a monitoring apparatus for monitoring vehicles, and such a monitoring apparatus causes a display device to display a situation of a monitoring target vehicle. In addition, when a state that needs attention in monitoring the vehicle (hereinafter, referred to as an “attention-needed state”) is detected, the monitoring apparatus displays a warning (alert), so that monitoring can be efficiently carried out. However, when many warnings occur relative to the number of monitoring persons, there is a possibility that a response delay might occur. For this reason, there is a demand for appropriately setting a warning occurrence condition.

As a related art, Patent Literature 1 discloses an information processing system of acquiring position information of a vehicle that is a monitoring target and determining a monitoring priority of the vehicle in accordance with movement information about movement of the vehicle. Such an information processing system generates presentation information for monitoring the vehicle, based on the monitoring priority, and causes a presentation device to output the presentation information.

In addition, in a case where there are a plurality of monitoring persons, the information processing system is capable of changing the monitoring priority in accordance with the experience in taking measures for the attention-needed state. For example, it is assumed that a monitoring person A has experienced taking measures for “junctions” more than a monitoring person B in the past. In this case, the information processing system is capable of changing the monitoring priority so that the monitoring person A is made to take measures for “junctions” with a higher priority than the monitoring person B.

### CITATION LIST

### Patent Literature

Patent Literature 1: Japanese Unexamined Patent Application Publication No. 2020-061121

### SUMMARY OF INVENTION

### Technical Problem

The monitoring ability of a monitoring person is desirably kept constant regardless of a monitoring timing. However, the monitoring ability may change depending on the monitoring person himself or herself or the surrounding situation. For example, when a monitoring person is not in a good physical condition, there is a possibility that the monitoring ability of such a monitoring person might degrade. Also in such a case, it is supposed that the monitoring capability of the entire monitoring center also degrades.

In consideration of the above-described problems, an object of the present disclosure is to provide an information processing apparatus, an information processing system, an information processing method, and a non-transitory computer-readable medium that are capable of appropriately monitoring vehicles in accordance with a situation of a monitoring person.

### Solution to Problem

An information processing apparatus according to the present disclosure includes:
acquisition means for acquiring vehicle situation information about a situation of a vehicle that is a monitoring target;
detection means for detecting an attention-needed state that needs attention in monitoring a vehicle, based on the vehicle situation information;
estimation means for estimating a characteristic of a monitoring person monitoring the vehicle, based on an image obtained by image-capturing the monitoring person; and
output control means for controlling an output of a warning about the attention-needed state to the monitoring person, based on the characteristic that has been estimated.

An information processing system according to the present disclosure includes:
a sensor configured to acquire vehicle situation information about a situation of a vehicle that is a monitoring target; and
an information processing apparatus, in which the information processing apparatus includes:
acquisition means for acquiring the vehicle situation information from the sensor;
detection means for detecting an attention-needed state that needs attention in monitoring a vehicle, based on the vehicle situation information;
estimation means for estimating a characteristic of a monitoring person monitoring the vehicle, based on an image obtained by image-capturing the monitoring person; and
output control means for controlling an output of a warning about the attention-needed state to the monitoring person, based on the characteristic that has been estimated.

An information processing method according to the present disclosure includes:
acquiring vehicle situation information about a situation of a vehicle that is a monitoring target;
detecting an attention-needed state that needs attention in monitoring a vehicle, based on the vehicle situation information;
estimating a characteristic of a monitoring person monitoring the vehicle, based on an image obtained by image-capturing the monitoring person; and
controlling an output of a warning about the attention-needed state to the monitoring person, based on the characteristic that has been estimated.

A non-transitory computer-readable medium storing a program according to the present disclosure for causing a computer to execute:
an acquisition process for acquiring vehicle situation information about a situation of a vehicle that is a monitoring target;
a detection process for detecting an attention-needed state that needs attention in monitoring a vehicle, based on the vehicle situation information;
an estimation process for estimating a characteristic of a monitoring person monitoring the vehicle, based on an image obtained by image-capturing the monitoring person; and
an output control process for controlling an output of a warning about the attention-needed state to the monitoring person, based on the characteristic that has been estimated.

### Advantageous Effects of Invention

According to the present disclosure, it is possible to provide an information processing apparatus, an information processing system, an information processing method, and a non-transitory computer-readable medium that are capable of appropriately monitoring vehicles in accordance with a situation of a monitoring person.

### BRIEF DESCRIPTION OF DRAWINGS

FIG. 1 is a block diagram illustrating a configuration of an information processing apparatus according to a first example embodiment.

FIG. 2 is a flowchart illustrating processing performed by the information processing apparatus according to the first example embodiment.

FIG. 3 is a block diagram illustrating a configuration of an information processing system according to a second example embodiment.

FIG. 4 is a diagram illustrating an example of an integrated monitoring screen and a detailed monitoring screen displayed on a display unit according to a second example embodiment.

FIG. 5 is a diagram illustrating an example of screen switching between the integrated monitoring screen and the detailed monitoring screen according to the second example embodiment.

FIG. 6 is a flowchart illustrating processing performed by the information processing apparatus according to the second example embodiment.

FIG. 7 is a block diagram illustrating a hardware configuration of a computer that implements an information processing apparatus and the like according to the second example embodiment.

### EXAMPLE EMBODIMENT

Hereinafter, example embodiments of the present disclosure will be described in detail with reference to the drawings. In the drawings, the same or corresponding elements are denoted by the same reference signs. For clarity of description, redundant description will be omitted as necessary.

### First Example Embodiment

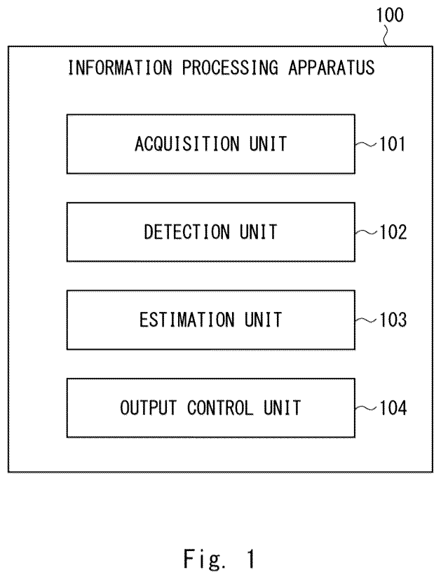

A first example embodiment will be described with reference to FIG. 1. FIG. 1 is a block diagram illustrating a configuration of an information processing apparatus 100 according to the present example embodiment. The information processing apparatus 100 includes an acquisition unit 101, a detection unit 102, an estimation unit 103, and an output control unit 104.

The acquisition unit 101 acquires vehicle situation information about a situation of a vehicle that is a monitoring target. The detection unit 102 detects an attention-needed state that needs attention in monitoring the vehicle, based on the vehicle situation information. The estimation unit 103 estimates a characteristic of a monitoring person monitoring the vehicle, based on an image of the monitoring person. The output control unit 104 controls an output of a warning about the attention-needed state to the monitoring person, based on the characteristic that has been estimated.

The information processing apparatus 100 includes a processor, a memory, and a storage device as configurations, not illustrated. The storage device stores a computer program on which processing according to the present example embodiment is implemented. The processor causes the computer program to be read from the storage device into a memory, and is capable of executing the computer program. Thus, the processor achieves the functions of the acquisition unit 101, the detection unit 102, the estimation unit 103, and the output control unit 104.

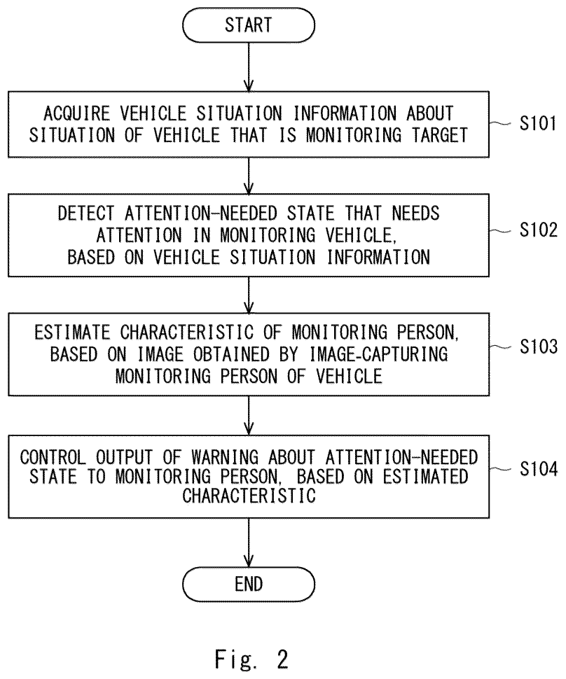

Subsequently, processing performed by the information processing apparatus 100 will be described with reference to FIG. 2. FIG. 2 is a flowchart illustrating the processing performed by the information processing apparatus 100.

First, the acquisition unit 101 acquires vehicle situation information about a situation of a vehicle that is a monitoring target (S101). Next, the detection unit 102 detects an attention-needed state that needs attention in monitoring the vehicle, based on the vehicle situation information (S102). Subsequently, the estimation unit 103 estimates a characteristic of a monitoring person, based on an image obtained by image-capturing the monitoring person monitoring the vehicle (S103). Then, the output control unit 104 controls the output of the warning about the attention-needed state to the monitoring person, based on the characteristic that has been estimated (S104).

With such a configuration, the information processing apparatus 100 according to the present example embodiment estimates the characteristic of the monitoring person using the image obtained by image-capturing the monitoring person. In addition, the information processing apparatus 100 controls the output of the warning, based on an estimation result. This enables the information processing apparatus 100 to appropriately monitor the vehicles in accordance with a situation of the monitoring person.

### Second Example Embodiment

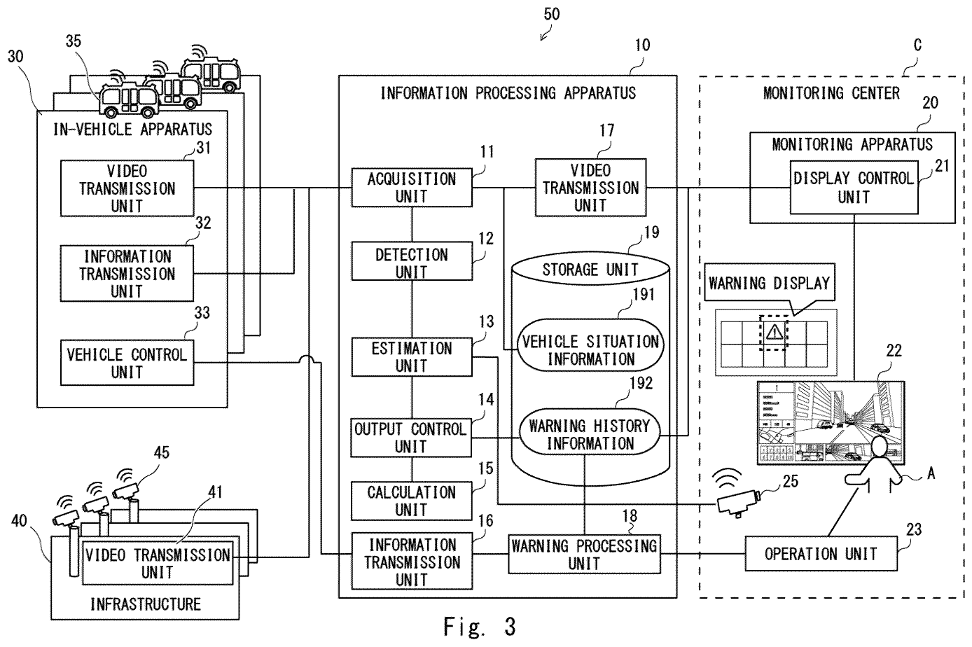

Subsequently, a second example embodiment will be described. The second example embodiment is a specific example of the above-described first example embodiment. FIG. 3 is a block diagram illustrating a configuration example of an information processing system 50 according to the present example embodiment. As illustrated in the drawing, the information processing system 50 includes an information processing apparatus 10, a monitoring apparatus 20, an in-vehicle apparatus 30, and an infrastructure 40. The information processing system 50 is an information processing system capable of monitoring vehicles present at remote locations, by performing predetermined information processing.

The information processing apparatus 10, the monitoring apparatus 20, the in-vehicle apparatus 30, and the infrastructure 40 are connected with one another through a network, not illustrated. Here, the network is a wired or wireless communication line. The network may be, for example, the Internet, a dedicated line, a telephone line, a mobile communication network, or any other communication line. In addition, the network may be a combination of them.

### (Monitoring Center C)

The monitoring center C denotes an area that serves as a base for remotely monitoring vehicles. In the monitoring center C, a monitoring person for monitoring the vehicles is arranged. Although one monitoring person A is illustrated in the drawing, a plurality of monitoring persons can be arranged in the monitoring center C.

The monitoring center C includes the monitoring apparatus 20, a display unit 22, an operation unit 23, and a monitoring person camera 25. Note that the display unit 22, the operation unit 23, and the monitoring person camera 25 are illustrated outside the monitoring apparatus 20 for the sake of description, but some or all of them may be configured to be built in the monitoring apparatus 20.

The monitoring apparatus 20 performs predetermined information processing for monitoring the vehicles. Examples of the monitoring apparatus 20 may include a personal computer (PC). Alternatively, the monitoring apparatus 20 may be configured to communicate with the information processing apparatus 10, the in-vehicle apparatus 30, or the infrastructure 40 on a web browser through the Internet or the like.

The display unit 22 displays a monitoring target vehicle. In addition, when the attention-needed state is detected, the display unit 22 displays a warning for the attention-needed state. The display unit 22 is, for example, a display device such as a display. The display unit 22 may be a display equipped with a touch panel or the like on which it is possible to perform an input operation by touching with a finger or the like. In addition, the monitoring center C can include a plurality of display units 22. The monitoring center C can include the display units 22 respectively corresponding to the plurality of monitoring persons.

Here, the attention-needed state indicates a state that needs attention in monitoring the vehicle. The attention-needed state is, for example, a state in which an abnormality occurs at a vehicle or an occupant. Examples of the abnormality of the vehicle include an abnormality of a vehicle body. Examples of the abnormality of the vehicle body include an abnormality related to the vehicle body such as a failure, an accident, or running out of electric power. In addition, the abnormality of the vehicle can include a stop of the vehicle due to these abnormalities. Examples of the abnormality of the vehicle can include a case where a bus or a truck cannot operate on time, and a case where a delay to a destination is occurring.

In addition, examples of the abnormality of the occupant include an abnormality of the driver or a passenger. Examples of the abnormality of the occupant include the driver or a passenger who is not in a good physical condition. Further, in a case where the vehicle is a bus or the like, a passenger feeling unwell, an injury of a passenger, a trouble between passengers, or a trouble in getting on or off of the passenger may be included in the abnormality of the passenger. Examples of the abnormality can include an occurrence of a situation in which the bus is incapable of starting due to passengers getting on or off, and emergence of a passenger who requests assistance.

Since the above-described abnormality is an example, the attention-needed state may include any other state. For example, the attention-needed state may be related to an environment in the surroundings of a vehicle. Examples of the attention-needed state can include collapse of a surrounding building, damage of a road facility, and an occurrence of a disaster.

The monitoring apparatus 20 includes a display control unit 21, which controls display on the display unit 22. The display control unit 21 acquires a video from the information processing apparatus 10, and causes the display unit 22 to display the video. The video may include a monitoring target vehicle. The display control unit 21 may display the video in real time. Note that in the present disclosure, the “video” means video data that is data of the video, in some cases. Similarly, in the present disclosure, an “image” means image data that is data of the image, in some cases.

In addition, the display control unit 21 acquires warning information from the information processing apparatus 10, and causes the display unit 22 to display a warning. The warning information is information for warning the monitoring person about the attention-needed state. The warning information may be information for notifying that the vehicle is in an attention-needed state. The warning information can include information for identifying the vehicle in which the attention-needed state has been detected and information about the content of the attention-needed state.

The warning information may be, for example, character information or image information indicating the attention-needed state. In addition, the warning information may be sound information output by a sound output device, not illustrated. The warning information is not limited to them, and various types of information such as illumination, buzzer, or vibration can be used. Further, the warning information may be a combination of the above-described pieces of information.

The monitoring person A illustrated in the drawing is able to monitor vehicles by visually recognizing the display of the display unit 22. In addition, the warning is output, and thus the monitoring person A is able to recognize the vehicle (hereinafter, referred to as an “attention-needed vehicle”, in some cases) in which the attention-needed state has been detected. This enables the monitoring person A to monitor the vehicle more carefully than usual. Further, the monitoring person A takes measures for the attention-needed vehicle as necessary.

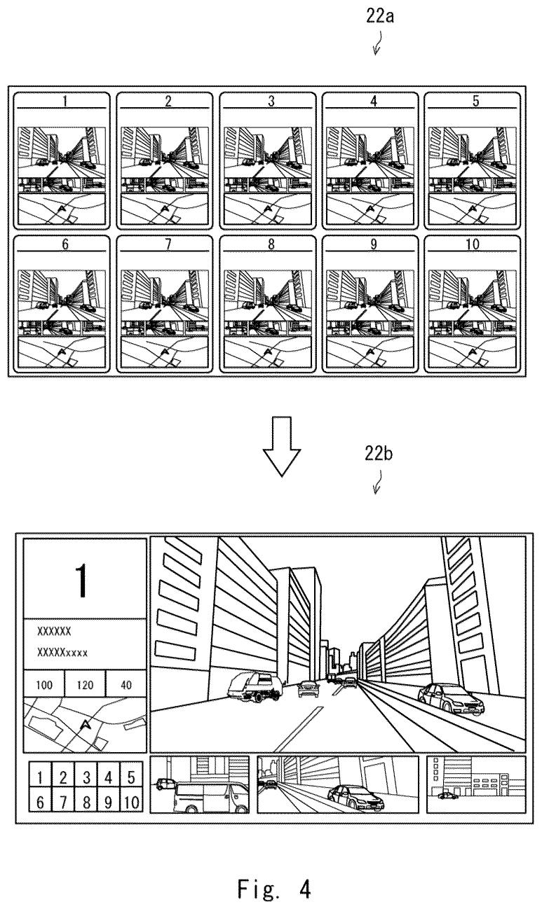

Here, an example of a screen displayed on the display unit 22 will be described with reference to FIG. 4. FIG. 4 is a diagram illustrating an example of an integrated monitoring screen 22a and a detailed monitoring screen 22b, each of which is displayed on the display unit 22. The integrated monitoring screen 22a is a screen for simultaneously displaying a plurality of vehicles. In addition, the detailed monitoring screen 22b is a screen for displaying a vehicle that needs attention or intervention of the monitoring person. In the example of the drawing, the integrated monitoring screen 22a displays a screen for monitoring each of the vehicles 1 to 10. Note that in the drawing, the same drawing is used as a screen display example of the vehicles 1 to 10, but actually, a video corresponding to each vehicle is displayed in each display area.

The display control unit 21 automatically switches between the integrated monitoring screen 22a and the detailed monitoring screen 22b in accordance with the situation of the vehicles 1 to 10. For example, when the attention-needed state is not detected in the vehicles 1 to 10, the display control unit 21 displays the integrated monitoring screen 22a. When the attention-needed state is detected in any of the vehicles 1 to 10, the display control unit 21 switches the display to the detailed monitoring screen 22b, which displays an attention-needed vehicle in the attention-needed state. The display control unit 21 may switch between the integrated monitoring screen 22a and the detailed monitoring screen 22b in accordance with an operation of the monitoring person.

The lower part of the drawing illustrates the detailed monitoring screen 22b when the attention-needed state of the vehicle 1 is detected. The display control unit 21 displays the detailed monitoring screen 22b for displaying the vehicle 1. For example, in a case where an abnormality is occurring inside or outside the vehicle 1 and necessitates measures to be taken, the monitoring person remotely operates the vehicle 1, and is able to avoid an accident or the like.

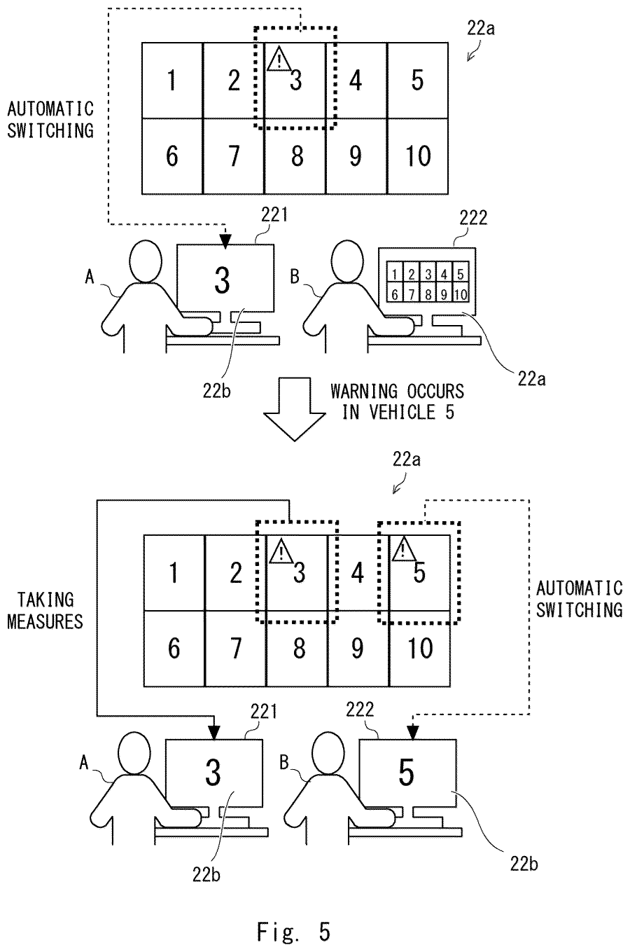

Here, with reference to FIG. 5, in a case where a plurality of monitoring persons are arranged, an example of switching between the screens on the display unit 22 will be described. FIG. 5 is a diagram illustrating an example of switching between the integrated monitoring screen 22a and the detailed monitoring screen 22b. Here, the monitoring persons A and B are arranged for monitoring. The monitoring person A uses a display unit 221, and the monitoring person B uses a display unit 222.

During normal monitoring, the display units 221 and 222 each display the integrated monitoring screen 22a. Therefore, the monitoring persons A and B each visually recognize the integrated monitoring screen 22a, and monitor vehicles.

The upper part of the drawing illustrates an example of a screen in a case where an attention-needed state has been detected in the vehicle 3 and a warning has been output. The display control unit 21 displays the warning in a display area of the vehicle 3. Here, it is assumed that the monitoring person A is in charge of monitoring the vehicle 3. The determination of a monitoring person in charge can be made by the information processing apparatus 10.

The display control unit 21 causes the display unit 221 to display the detailed monitoring screen 22b, which is related to the vehicle 3. The display control unit 21 displays the detailed monitoring screen 22b for displaying the vehicle 3 from the integrated monitoring screen 22a, which had been displayed until then. Thus, when a warning occurs at the vehicle 3, the screen of the display unit 221 is automatically switched to the detailed monitoring screen 22b. The monitoring person A visually recognizes the detailed monitoring screen 22b after switching, and monitors the vehicle 3. Note that in the example of the drawing, the monitoring person B visually recognizes the usual integrated monitoring screen 22a, and continues monitoring.

Here, it is assumed that an attention-needed state has been detected in the vehicle 5 and a warning has been generated. For example, the display control unit 21 identifies screens displayed on the respective display units 221 and 222, and selects a display unit to be caused to display the detailed monitoring screen 22b of the vehicle 5. As illustrated in the drawing, here, it is assumed that the monitoring person A is taking measures for the situation of the vehicle 3, and the display unit 221 is displaying the detailed monitoring screen 22b of the vehicle 3.

The display control unit 21 selects the display unit 222 on which the integrated monitoring screen 22a is being displayed, and displays the detailed monitoring screen 22b, which is related to the vehicle 5. Thus, when a warning occurs at the vehicle 5, the display screen of the display unit 222 is automatically switched to the detailed monitoring screen 22b. The monitoring person B is able to monitor the vehicle 5 by visually recognizing the display unit 222.

In this manner, the display control unit 21 switches the display on the display unit 22 in accordance with the presence or absence of the attention-needed vehicle. This enables reductions in monitoring load and operation load of the monitoring person. In addition, it becomes possible for a small number of monitoring persons to monitor a large number of vehicles.

Returning to FIG. 3, the description of the monitoring center C will be continued. The operation unit 23 receives an operation from a monitoring person. The operation unit 23 receives, for example, an input of an instruction given by the monitoring person to a vehicle 35. The operation unit 23 transmits the received content to the information processing apparatus 10. The monitoring person operates the operation unit 23, and is able to remotely operate the vehicle 35. This enables the monitoring person to take measures for the abnormality of the vehicle or the occupant, and to eliminate the attention-needed state.

The monitoring person camera 25 is an image capturing apparatus for image-capturing the monitoring person. The monitoring person camera 25 is provided at, for example, a predetermined position in the monitoring center C. The monitoring person camera 25 transmits, to the information processing apparatus 10, an image (hereinafter, referred to as a “monitoring person image”, in some cases) that has been captured by the monitoring person camera 25. The image may be a still image or a moving image. Note that a microphone that acquires voices emitted from the monitoring person may be provided together with the monitoring person camera 25.

Here, an example of monitoring by the monitoring person will be described. The monitoring person monitors a traffic scene with a high degree of risk. The traffic scene with a high degree of risk is, for example, a place with a large traffic volume, a place with a large number of people, or a place with a blind spot. The monitoring person also monitors driving by the driver of the vehicle 35. For example, the monitoring person monitors whether the driver is driving safely. Specifically, the monitoring person monitors whether the driver temporarily stops, follows a signal, keeps a limit speed, and the like.

In addition, the monitoring person monitors an operation state of the vehicle 35. The monitoring person monitors whether the vehicle 35 is traveling or stopped, the traveling position of the vehicle 35, whether the vehicle 35 is being operated as planned, and the like.

In addition, an example of an operation performed by the monitoring person will be described. The monitoring person instructs the vehicle 35 using the operation unit 23 via the information processing apparatus 10. This enables the operation unit 23 to receive an input from the monitoring person, and to control the vehicle 35.

For example, the monitoring person intervenes in driving control of the vehicle 35. The monitoring person may cause the vehicle 35 to perform predetermined automatic driving, or the monitoring person may drive manually to directly operate the vehicle 35. Examples of the predetermined automatic driving include immediately stopping the vehicle 35, and moving the vehicle 35 to a road side and then stopping the vehicle. The monitoring person can switch (override) from the manual driving to the automatic driving or from the automatic driving to the manual driving.

When being switched to the manual driving, the operation unit 23 performs the manual driving of the vehicle 35 in accordance with an operation of the monitoring person. Thus, the monitoring person remotely operates the vehicle 35 using the operation unit 23. For example, by giving an emergency stop instruction to the vehicle 35, the monitoring person makes an emergency stop of the vehicle 35. In addition, the monitoring person may provide in-vehicle broadcasting to passengers of the vehicle 35.

Note that although the present example embodiment illustrates an example in which the monitoring person takes measures for the attention-needed state, the monitoring center C may separately arrange an operator for taking measures for the attention-needed state.

### (In-Vehicle Apparatus 30)

The in-vehicle apparatus 30 is an information processing apparatus mounted in the vehicle 35, which is a monitoring target. The in-vehicle apparatus 30 is a so-called edge-side apparatus. The in-vehicle apparatus 30 acquires vehicle situation information about the situation of the vehicle that is a monitoring target by using a sensor, not illustrated, and transmits the vehicle situation information to the information processing apparatus 10. The in-vehicle apparatus 30 may be provided in each of the plurality of monitoring target vehicles. The vehicle situation information is, for example, an image obtained by image-capturing the vehicle or the surroundings of the vehicle. Other examples of the vehicle situation information include three-dimensional measurement information measured by a sensor such as a laser, a radar, or a light detection and ranging or laser imaging detection and ranging (LiDAR). The vehicle situation information may be speed, acceleration, or the like of the vehicle 35. The vehicle situation information may be operation information of the vehicle 35, such as a steering wheel angle, a brake pressure, or opening and closing of a vehicle door. The vehicle situation information may be position information of the vehicle 35.

The in-vehicle apparatus 30 includes a video transmission unit 31, an information transmission unit 32, and a vehicle control unit 33. The video transmission unit 31 transmits a video that has been obtained by video-capturing the situation of the vehicle 35 to the information processing apparatus 10. Such a video is imaged by using a camera, not illustrated. Such a camera is provided inside or outside the cabin of the vehicle 35, and can image the inside or the outside of the vehicle. The vehicle 35 may include both an in-vehicle camera and a camera outside the vehicle. The image of the inside of the vehicle can include an image of an occupant in the vehicle. For example, in a case where the vehicle 35 is a bus, a taxi, or the like, the video transmission unit 31 acquires a video including a passenger, and transmits the video. Note that although not illustrated, the in-vehicle apparatus 30 may acquire information of sounds generated inside and outside the vehicle 35, without being limited to the video, and may transmit the information to the information processing apparatus 10.

The information transmission unit 32 acquires information from a sensor, not illustrated, included in the vehicle 35, and transmits the acquired information to the information processing apparatus 10. For example, the information transmission unit 32 acquires position information of the vehicle 35 using a position sensor. The position sensor detects a current position of the vehicle 35. The position sensor receives positioning signals transmitted from a plurality of artificial satellites of, for example, a global navigation satellite system (GNSS), and measures the position based on these positioning signals.

The information transmission unit 32 may acquire information about the vehicle 35, in addition to the position information, and may transmit the information to the information processing apparatus 10.

The vehicle control unit 33 receives instruction information from the information processing apparatus 10. The vehicle control unit 33 controls traveling and movement of the vehicle 35, based on the instruction information. For example, the vehicle control unit 33 controls traveling of the vehicle 35 using a vehicle control electronic control unit (ECU), not illustrated, in accordance with an instruction from the information processing apparatus 10. The vehicle control ECU can include, for example, a power unit control ECU, which conducts acceleration and deceleration control of the vehicle 35, a brake ECU, and the like.

### (Infrastructure 40)

The infrastructure 40 denotes a facility (for example, a traffic light) provided in the vicinity of the road. The infrastructure 40 includes a sensor that acquires the vehicle situation information. Here, an infrastructure camera 45 will be described as an example of the sensor. The infrastructure camera 45 is an image capturing apparatus for image-capturing a road or the surroundings of the road. In addition, the infrastructure camera 45 may include a microphone that acquires sounds on the road or the surroundings of the road.

The video transmission unit 41 transmits the video that has been acquired by the infrastructure camera 45 to the information processing apparatus 10. The video transmission unit 41 may be provided in an information processing apparatus such as a PC. Note that the information processing system 50 may include another configuration capable of transmitting the vehicle situation information to the information processing apparatus 10, in addition to the in-vehicle apparatus 30 and the infrastructure 40. Further, the information processing system 50 may include either one of the in-vehicle apparatus 30 or the infrastructure 40.

### (Information Processing Apparatus 10)

The information processing apparatus 10 is an example of the above-described information processing apparatus 100. The information processing apparatus 10 includes an acquisition unit 11, a detection unit 12, an estimation unit 13, an output control unit 14, a calculation unit 15, an information transmission unit 16, a video transmission unit 17, a warning processing unit 18, and a storage unit 19. The information processing apparatus 10 may be implemented on, for example, a cloud computing system.

The acquisition unit 11 is an example of the above-described acquisition unit 101. The acquisition unit 11 acquires the vehicle situation information including information about a situation of the vehicle. The vehicle situation information is, for example, a video obtained by video-capturing a vehicle or the surroundings of the vehicle. In addition, the vehicle situation information may be position information of the vehicle.

The detection unit 12 is an example of the above-described detection unit 102. The detection unit 12 detects the attention-needed state of the vehicle, based on the vehicle situation information. For example, the detection unit 12 detects the attention-needed state, based on the video that has been transmitted from the in-vehicle apparatus 30. The detection unit 12 can detect the attention-needed state using a known image recognition technology.

For example, the detection unit 12 estimates the pose of an occupant in the vehicle. Thus, the detection unit 12 detects that, for example, a passenger of the bus has fallen. In addition, the detection unit 12 may recognize an object, based on an image. The detection unit 12 detects, for example, a child who has run out in front of the vehicle. Upon detection of any of these situations, the detection unit 12 detects that the vehicle has transitioned to the attention-needed state.

Further, the detection unit 12 may detect the attention-needed state, based on the position information of the vehicle 35 that has been transmitted from the in-vehicle apparatus 30. For example, the detection unit 12 detects a movement situation of the vehicle 35, based on a change in position information. The detection unit 12 detects the attention-needed state, in a case where the movement situation of the vehicle 35 does not satisfy a predetermined condition. The predetermined condition may be, for example, an arrival time at a destination. The predetermined condition can be set beforehand. The predetermined condition may be set using a traveling route, a traveling speed, or the like.

The detection unit 12 can appropriately set a detection level of the attention-needed state. For example, the detection unit 12 may set the detection level, based on a priority corresponding to the attention-needed state. The priority can be set beforehand in accordance with an attention-needed level indicated by the attention-needed state. The attention-needed level is, for example, information indicating a possibility degree that a vehicle or an occupant will be in danger. As the possibility of an occurrence of a serious accident or trouble increases, the attention-needed level increases. The priority can be set to correspond to the importance of taking measures by the monitoring person for the attention-needed state.

The detection level can be set beforehand in accordance with a monitoring quality demanded by an administrator, for example, upon receipt of an input from the administrator of the information processing system 50. The detection unit 12 sets the detection level to detect a lower level of the attention-needed state, as the monitoring quality is higher. The detection unit 12 may select a vehicle for which the attention-needed state is to be detected, based on a vehicle type or the like.

The estimation unit 13 is an example of the above-described estimation unit 103. The estimation unit 13 estimates a characteristic of a monitoring person (hereinafter, referred to as a “monitoring person characteristic”, in some cases), based on an image that has been obtained by image-capturing the monitoring person who is monitoring vehicles. Here, the monitoring person characteristic indicates a characteristic that the monitoring person has. The monitoring person characteristic can affect a monitoring quality.

Specifically, the estimation unit 13 acquires a monitoring person image captured by the monitoring person camera 25. By using an image recognition technology or the like, the estimation unit 13 can estimate the characteristic of the monitoring person included in the monitoring person image. The monitoring person image may include a plurality of monitoring persons.

The monitoring person characteristic can include, for example, information of the number of persons indicating the number of monitoring persons arranged in the monitoring center C. The estimation unit 13 acquires the information of the number of persons, based on the monitoring person image.

In addition, the monitoring person characteristic can include physical condition information about a physical condition of the monitoring person. Examples of the physical condition information include information indicating a physical condition, a health condition, a fatigue level, strength of sleepiness, a heart rate, and a concentration level of a monitoring person. The estimation unit 13 estimates the physical condition information, based on the monitoring person image. For example, the estimation unit 13 detects movements of the line of sight of the monitoring person, based on the monitoring person image. For example, by calculating the number of occurrence times that the monitoring person looks aside, the estimation unit 13 is capable of estimating the concentration level of the monitoring person. In addition to the monitoring person image, the estimation unit 13 may estimate the physical condition information, based on the physical condition or the like that has been declared by the monitoring person.

Note that in a case where there are a plurality of monitoring persons, the estimation unit 13 can estimate the physical condition information of each of the plurality of monitoring persons.

The output control unit 14 is an example of the above-described output control unit 104. The output control unit 14 controls an output of a warning about the attention-needed state to the monitoring person, based on the monitoring person characteristic that has been estimated.

The output control unit 14 controls an output amount of the warning or an output destination of the warning, based on, for example, the monitoring person characteristic. The output amount indicates the number of warnings to be output on the display unit 22. The output amount may be the number of warnings to one monitoring person or the total number of warnings to a plurality of monitoring persons.

The output destination indicates a display destination on which a warning is displayed. The display destination indicates a monitoring person in charge who is in charge for taking measures for the warning. The output control unit 14 controls the output destination of the warning, by switching the screen of the display unit 22 of the monitoring person in charge from the integrated monitoring screen 22a to the detailed monitoring screen 22b.

For example, the output control unit 14 controls the output amount of the warning, based on the information of the number of persons. For example, it is assumed that five persons are arranged in the monitoring center C. The output control unit 14 determines an output amount of the warning that five monitoring persons are able to take measures. The output amount that one person is able to take measures may be set beforehand. In addition, an output amount that every monitoring person is able to take measures may be set. Furthermore, an output amount for which the measures can be taken for every content may be set. The output control unit 14 determines the output amount of the warning with an upper limit of the output amount that one or a plurality of arranged monitoring persons are able to take measures. This enables the output control unit 14 to adjust output frequency of the warning.

In addition, the output control unit 14 may control the output destination of the warning, based on the physical condition information. The output control unit 14 compares the physical condition information of a plurality of monitoring persons, and determines the output destination of a monitoring person in a good physical condition to have a priority over a monitoring person who does not need a physical condition.

In addition, the output control unit 14 may control the output of the warning, based on the priority corresponding to the attention-needed state. For example, the output control unit 14 determines the output amount to output warnings having five highest priorities.

The output control unit 14 may determine the output amount to output a warning for an attention-needed state with a priority equal to or higher than a predetermined threshold. The predetermined threshold may be set beforehand. Further, the threshold value may be appropriately changed in accordance with a demanded monitoring quality or the like.

In addition, the output control unit 14 may determine the output amount, based on a predetermined bias or weighting. The predetermined bias and weighting may be set beforehand, and may be appropriately changed. For example, the output control unit 14 determines the total number of warnings to be output, based on a bias that has been set with respect to the total number of warnings. Further, for example, the output control unit 14 determines the output amount of the warning, based on weighting set in accordance with the content of the attention-needed state. In this manner, the output control unit 14 is capable of determining the output amount using the weighting in accordance with the priority.

The output control unit 14 may control the output of the warning in accordance with the amount of the attention-needed state that has been detected in one vehicle. For example, the output control unit 14 may determine the output amount so as to warn only when there are a plurality of attention-needed states.

In addition, the output control unit 14 may control the output destination of the warning, further based on ability information indicating an ability of the monitoring person. The ability information can include history information indicating a situation of driving assistance that has been conducted by the monitoring person in the past. Here, the history information is stored, as warning history information 192, in the storage unit 19. The output control unit 14 refers to the warning history information 192, and determines a monitoring person who is able to appropriately take measures for the warning, as the output destination.

In this manner, the output control unit 14 is capable of distributing the warning to the monitoring person who has a thorough knowledge in taking measures for a specific attention-needed state. Note that the output control unit 14 may determine the output destination, based on information of suitability or the like of the monitoring person, without being limited to the warning history information 192.

Examples of how to distribute the warning based on the ability information include the following ones.
(1) Vehicle type (example: large/medium/small; bus/truck/motorcycle/passenger car; manufacturer; construction machine/agricultural machine/passenger car)
(2) Region (example: Kanto region/Kansai region/Chubu region)
(3) Business type (example: bus company/transportation/taxi)
(4) Nation (example: China/Russia/India/USA/Europe)
(5) Language (example: Spanish/English/Chinese)
(6) Presence or absence of a case example for which measures have been taken in the past (example: warning/major road/route/scene)

The calculation unit 15 calculates a characteristic of the monitoring person necessary for obtaining a predetermined monitoring quality. The predetermined monitoring quality may be set beforehand by an administrator or the like of the information processing system 50. The calculation unit 15 can calculate the characteristic of the necessary monitoring person, based on a predetermined detection amount of the attention-needed state. The predetermined detection amount may be an amount in which detection of the attention-needed state is assumed, or may be a fixed value.

For example, the calculation unit 15 calculates the number of monitoring persons necessary for obtaining the monitoring quality, based on a predetermined detection amount and a demanded monitoring quality. In addition, for example, the calculation unit 15 calculates the ability information of the monitoring person necessary for obtaining such a monitoring quality, and identifies the monitoring person having such ability information. This enables arrangement of a monitoring person necessary for obtaining the predetermined monitoring quality.

In this manner, it becomes possible to construct a monitoring system in accordance with the situation of the monitoring person. In addition, in a case where the number of monitoring persons is insufficient to obtain a predetermined monitoring quality, it is possible to consider an increase in the number of monitoring persons. Further, since the monitoring person characteristic necessary for obtaining the predetermined monitoring quality is calculated, the information processing system 50 is capable of optimizing the monitoring system in accordance with an actual situation at an actual scene. In addition, it becomes possible to prevent an excessive load from being applied to the monitoring person, thereby leading to management of the monitoring persons.

Examples of optimization in accordance with the actual situation at the actual scene include the following ones.
(1) Number of monitoring persons (load settings corresponding to the number of monitoring persons)
(2) Monitoring person skill (monitoring assignment corresponding to skill registered beforehand)
(examples of skill: vehicle type, region, driving skill, cumulative monitoring time)
(3) Monitoring time (acquisition situation of break time)
(4) Monitoring person assignment (skilled personnel, assignment of necessary number of persons, increase in the number of persons, and assignment plan, in accordance with a monitoring situation)
(5) Monitoring mode switching (example: careful monitoring/best effort occurrence order/priority order)

The information transmission unit 16 transmits information to the in-vehicle apparatus 30. The information transmission unit 16 transmits, to the information processing apparatus 10, for example, the instruction information that has been generated by the warning processing unit 18.

The video transmission unit 17 transmits the video that has been acquired by the acquisition unit 11 to the monitoring apparatus 20. The video transmission unit 17 may transmit the video at predetermined time intervals. For example, the video transmission unit 17 transmits a video in real time. This enables the monitoring person to monitor the situation of the vehicle in real time.

The warning processing unit 18 performs processing for a warning. The warning processing unit 18 generates instruction information indicating an instruction to control the vehicle 35, which is in the attention-needed state. The warning processing unit 18 transmits the instruction information that has been generated to the in-vehicle apparatus 30 via the information transmission unit 16. The warning processing unit 18 stores the history of outputting the warning, as the warning history information 192, in the storage unit 19.

In addition, for example, the warning processing unit 18 may instruct the in-vehicle apparatus 30 to connect the monitoring apparatus 20 with the in-vehicle apparatus 30 so that in-vehicle broadcasting from the monitoring center C to the vehicle 35 is enabled.

For example, it is assumed that the vehicle 35 in the attention-needed state is a bus. The warning processing unit 18 causes the in-vehicle broadcasting to be performed using a microphone provided in the bus. This enables talking to passengers in the bus from the monitoring center C. Examples of the in-vehicle broadcasting include broadcasting for taking measures for an in-vehicle trouble or the like, and broadcasting for preventing an accident or the like from occurring.

In the storage unit 19, vehicle situation information 191 and the warning history information 192 are written. In addition, the storage unit 19 stores a computer program in which processing of an information processing method according to the present example embodiment is implemented.

The vehicle situation information 191 is information about the situation of the monitoring target vehicle. The vehicle situation information 191 is, for example, an image inside and outside the vehicle and position information of the vehicle. The vehicle situation information 191 may include information other than the video and the position information.

The warning history information 192 is information about a warning to a monitoring person. The warning history information 192 is, for example, information in which a warning date and time, a warning content, a monitoring person in charge, contents of measures that have been taken, or the like is associated.

Heretofore, the configuration included in the information processing system 50 has been described. Note that the above-described configuration of the information processing system 50 is merely an example, and can be appropriately changed. For example, in a case where some or all of the component elements of the information processing apparatus 10 are implemented by a plurality of information processing apparatuses, circuits, or the like, the plurality of information processing apparatuses, circuits, or the like may be disposed in a centralized manner or in a distributed manner. For example, the information processing apparatuses, the circuits, or the like may be implemented in the form of a client server system, a cloud computing system, or the like in which they are connected to each other through a communication network. In addition, the functions of the information processing apparatus 10 may be provided in the form of software as a service (Saas).

For example, in the example of FIG. 3, the information processing apparatus 10 is provided outside the monitoring center C, but the information processing apparatus 10 may be provided in the monitoring center C. Further, the monitoring apparatus 20 may be configured to have the functions of the information processing apparatus 10.

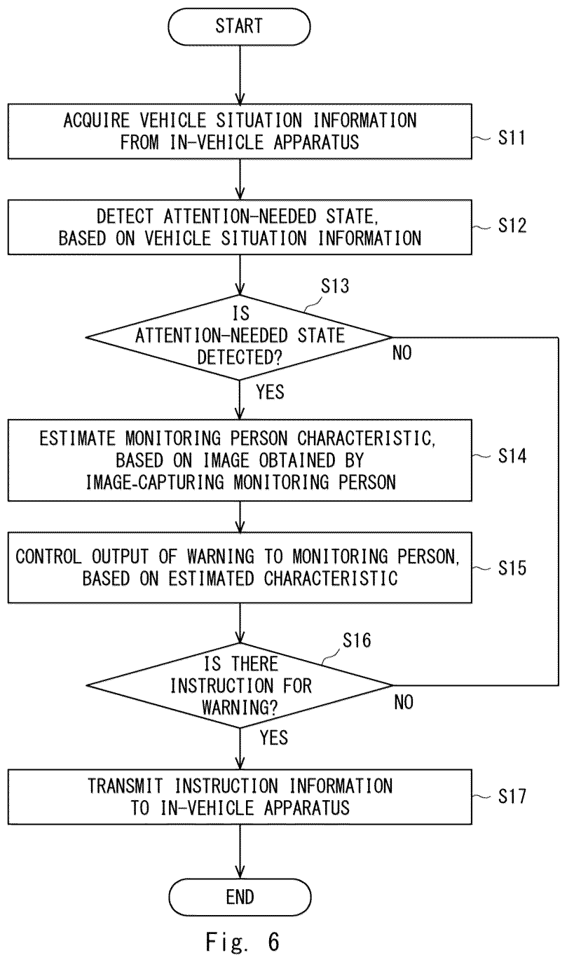

Subsequently, processing performed by the information processing apparatus 10 will be described with reference to FIG. 6. FIG. 6 is a flowchart illustrating the processing performed by the information processing apparatus 10. Here, as illustrated in FIG. 3, it is assumed that a plurality of vehicles 35 are monitoring targets. In addition, in the monitoring center C, as illustrated in the example of FIG. 5, it is assumed that a plurality of monitoring persons are arranged. Then, in the monitoring center C, it is assumed that the monitoring person camera 25 is image-capturing a plurality of monitoring persons.

First, the acquisition unit 11 acquires vehicle situation information from the in-vehicle apparatus 30 (S11). The vehicle situation information is, for example, a video inside or outside the vehicle 35, position information of the vehicle 35, or the like.

Next, the detection unit 12 detects the attention-needed state of the vehicle 35, based on the vehicle situation information (S12). For example, the detection unit 12 detects the attention-needed state using a known image recognition technology for the video that has been acquired. For example, the detection unit 12 detects a child who has jumped out in front of the vehicle 35, an abnormality on a road, a trouble between passengers in the vehicle, or the like.

Subsequently, the estimation unit 13 determines whether the attention-needed state has been detected in the vehicle 35 (S13). In a case where the attention-needed state is not detected (NO in S13), the processing returns to step S11. In a case where the attention-needed state is detected (YES in S13), the estimation unit 13 estimates a monitoring person characteristic, based on the image that has been obtained by image-capturing the monitoring person (S14).

Examples of the monitoring person characteristic may include information of the number of persons indicating the number of monitoring persons, and physical condition information indicating the physical condition of the monitoring person. Examples of the physical condition information include information indicating a physical condition, a health condition, a fatigue level, strength of sleepiness, a heart rate, and a concentration level of a monitoring person. The estimation unit 13 can estimate the information of the number of persons or the physical condition information using the image recognition technology.

Subsequently, the output control unit 14 controls an output of a warning to the monitoring person, based on the characteristic that has been estimated (S15). For example, the output control unit 14 controls an output amount or an output destination of the warning to the display unit 22, based on the monitoring person characteristic. The output amount may be the number of warnings to one monitoring person or the total number of warnings to a plurality of monitoring persons. The output control unit 14 controls the output amount of the warning in accordance with the information of the number of persons.

The output control unit 14 may control the output of the warning, based on the priority corresponding to the attention-needed state. In addition, the output control unit 14 may control the output of the warning in accordance with the amount of the attention-needed state that has been detected in one vehicle. For example, the output control unit 14 may control the output so as to output a warning when an attention-needed state equal to or larger than a threshold value is detected.

In addition, the output control unit 14 may determine a monitoring person to be in charge of the vehicle in which the attention-needed state occurs and the vehicle becomes a monitoring target, and may control an output destination of the warning. The output control unit 14 switches the screen display of the display unit 22 used by the monitoring person in charge. The example of the screen switching has been described using the examples illustrated in FIGS. 4 and 5. The output control unit 14 controls the output destination of the warning, by switching the screen of the display unit 22 of the monitoring person in charge from the integrated monitoring screen 22a to the detailed monitoring screen 22b.

Furthermore, the output control unit 14 may control the output of the warning, further based on the ability information indicating the ability of the monitoring person. For example, the output control unit 14 refers to the warning history information 192, and acquires the situation of the driving assistance that has been conducted by the monitoring person. The output control unit 14 determines a monitoring person who is able to take measures for the attention-needed state that has been detected, as a monitoring person in charge.

Subsequently, the warning processing unit 18 determines whether there is an instruction from the monitoring person for the warning (S16). The warning processing unit 18 receives an instruction from the monitoring person via the operation unit 23. In a case where there is no instruction from the monitoring person (NO in S16), the processing returns to step S11. Alternatively, the output control unit 14 may issue a warning again, or may change the person in charge and output a warning to another monitoring person. In a case where there is the instruction from the monitoring person (YES in S16), the warning processing unit 18 generates instruction information, and transmits the instruction information to the in-vehicle apparatus 30 (S17).

Thus, the vehicle 35 performs automatic driving in accordance with the instruction information. Alternatively, the vehicle 35 may be manually driven by a remote operation of the monitoring person. The vehicle 35 may broadcast the voices of the monitoring person or the like in the vehicle.

Note that although not illustrated in the drawing, the calculation unit 15 may calculate the characteristic of the monitoring person necessary for obtaining a predetermined monitoring quality. Thus, for example, it becomes possible to obtain the number of monitoring persons and skills necessary for obtaining the predetermined monitoring quality.

In addition, the order of the processing illustrated in FIG. 6 may be appropriately changed. For example, in the drawing, an example in which after the attention-needed state is detected, the monitoring person characteristic is estimated has been described (S13, S14). Without being limited to this, the estimation unit 13 may acquire the monitoring person image at predetermined time intervals, and may estimate the monitoring person characteristic at any time. In this manner, the estimation unit 13 can estimate the number of monitoring persons and the physical condition information of the monitoring person beforehand.

As described heretofore, in the information processing system 50 according to the present example embodiment, the information processing apparatus 10 estimates the characteristic of the monitoring person, based on the image obtained by image-capturing the monitoring person monitoring the vehicles. The information processing apparatus 10 controls the output of the warning to the monitoring person, based on the characteristic that has been estimated.

In this manner, the information processing apparatus 10 is capable of outputting a warning suitable for the physical condition or the ability of the monitoring person, while controlling the amount of warning issued for the monitoring person. This enables a balance between the monitoring person and the warning amount.

For example, the information processing apparatus 10 is capable of setting a warning amount (workload) in accordance with the number of monitoring persons or the processing ability of the monitoring person. This enables the warning amount to be adjusted to an appropriate warning amount from the viewpoint of the monitoring person. In this manner, one monitoring person is able to monitor a plurality of vehicles (for example, five vehicles). Therefore, it becomes possible to construct a monitoring system without causing a shortage of monitoring persons.

In addition, in a case where the number of warnings is smaller than the number of monitoring persons, the monitoring person is awaiting. However, in the information processing system 50 according to the present example embodiment, it becomes possible to calculate an appropriate number of monitoring persons, so that such a problem can also be solved.

Further, since the information processing apparatus 10 is capable of appropriately determining a monitoring person who takes measures for the detected attention-needed state, for example, in a case where the vehicle is abnormally stopped, it becomes possible to grasp the presence or absence of a factor that hinders traveling and quickly identify the factor. In addition, since the information processing apparatus 10 is capable of assigning a monitoring person to an attention-needed vehicle in accordance with the ability of the monitoring person, the monitoring person is able to quickly eliminate the attention-needed state.

In this manner, the monitoring person appropriately monitors the vehicle and remotely operates the vehicle in accordance with the situation, and thus the information processing apparatus 10 is capable of causing the vehicle to appropriately travel. For example, in a case where the vehicle is a bus or the like, it becomes possible to operate the vehicle on time without stopping the vehicle at an unexpected place. In addition, also when a trouble occurs inside or outside the vehicle, it becomes possible to find the trouble promptly and take measures for the trouble quickly. This enables a prompt recovery of the situation and a restart of the operation.

Therefore, according to the information processing system 50 according to the present example embodiment, it becomes possible to appropriately monitor the vehicle in accordance with the situation of the monitoring person.

### (Example of Hardware Configuration)

Each functional configuration unit of the information processing apparatus 10, the monitoring apparatus 20, and the in-vehicle apparatus 30 (hereinafter referred to as “information processing apparatus 10 and the like”) may be implemented by hardware (for example, a hard-wired electronic circuit or the like) that implements each functional component, or may be achieved by a combination of hardware and software (for example, a combination of an electronic circuit and a program that controls the electronic circuit, or the like). Hereinafter, a case where each functional configuration unit of the information processing apparatus 10 and the like is achieved by a combination of hardware and software will be described.

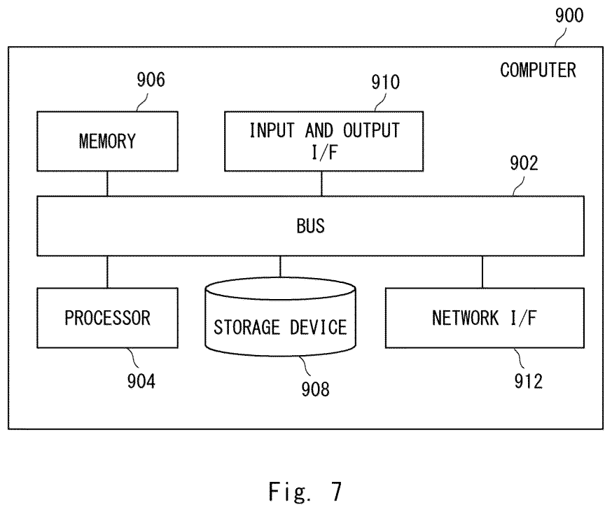

FIG. 7 is a block diagram illustrating a hardware configuration of a computer 900, which achieves the information processing apparatus 10 and the like. The computer 900 may be a dedicated computer designed to achieve the information processing apparatus 10 and the like, or may be a general-purpose computer. The computer 900 may be a portable computer such as a smartphone or a tablet terminal.

For example, by installing a predetermined application in the computer 900, each function of the information processing apparatus 10 and the like is implemented on the computer 900. The above application is configured with a program for achieving a functional configuration unit of the information processing apparatus 10 and the like.

The computer 900 includes a bus 902, a processor 904, a memory 906, a storage device 908, an input and output interface 910, and a network interface 912. The bus 902 is a data transmission path for the processor 904, the memory 906, the storage device 908, the input and output interface 910, and the network interface 912 to transmit and receive data to and from each other. However, a method for connecting the processor 904 and the like to each other is not limited to the bus connection.

The processor 904 denotes various processors such as a central processing unit (CPU), a graphics processing unit (GPU), a field-programmable gate array (FPGA), and a quantum processor (quantum computer control chip). The memory 906 is a main storage device achieved with use of a random access memory (RAM) or the like. The storage device 908 is an auxiliary storage device achieved with use of a hard disk, a solid state drive (SSD), a memory card, a read only memory (ROM), or the like.

The input and output interface 910 is an interface for connecting the computer 900 with an input and output device. For example, an input device such as a keyboard and an output device such as a display device are connected with the input and output interface 910.

The network interface 912 is an interface for connecting the computer 900 to a network. Such a network may be a local area network (LAN) or a wide area network (WAN).

The storage device 908 stores a program for implementing each functional configuration unit of the information processing apparatus 10 and the like (a program for achieving the above-described application). The processor 904 reads such a program into the memory 906, and executes the program to implement each functional configuration unit of the information processing apparatus 10 and the like.

Each of the processors executes one or more programs including an instruction group for causing a computer to perform the algorithm that has been described with reference to the drawing. The program includes an instruction group (or software codes) for causing the computer to perform one or more functions that have been described in the example embodiments, when the program is read by the computer. The program may be stored in various types of a non-transitory computer-readable medium or a tangible storage medium. Without being limited, but examples of the non-transitory computer-readable medium or the tangible storage medium include a random-access memory (RAM), a read-only memory (ROM), a flash memory, a solid-state drive (SSD) or any other memory technology, a CD-ROM, a digital versatile disc (DVD), a Blu-ray (registered trademark) disk or any other optical disk storage, a magnetic cassette, a magnetic tape, a magnetic disk storage, or any other magnetic storage device. The program may also be transmitted in various types of the transitory computer-readable medium or a communication medium. Without being limited, but examples of the transitory computer-readable medium or the communication medium include an electric signal, an optical signal, an acoustic signal, or any other form of propagation signal.

Note that the present disclosure is not limited to the above example embodiments, and can be appropriately changed without departing from the gist.

Some or all of the above-described example embodiments may be described as in the following Supplementary Notes, but are not limited to the following ones.

### (Supplementary Note 1)

An information processing apparatus includes:
acquisition means for acquiring vehicle situation information about a situation of a vehicle that is a monitoring target;
detection means for detecting an attention-needed state that needs attention in monitoring a vehicle, based on the vehicle situation information;
estimation means for estimating a characteristic of a monitoring person monitoring the vehicle, based on an image obtained by image-capturing the monitoring person; and
output control means for controlling an output of a warning about the attention-needed state to the monitoring person, based on the characteristic that has been estimated.

### (Supplementary Note 2)

The information processing apparatus described in Supplementary Note 1, in which
the characteristic includes information of the number of persons indicating the number of monitoring persons, and
the output control means controls the output of the warning, based on the information of the number of persons.

### (Supplementary Note 3)

The information processing apparatus described in Supplementary Note 1 or 2, in which
the characteristic includes physical condition information indicating a physical condition of the monitoring person, and
the output control means controls the output of the warning, based on the physical condition information.

### (Supplementary Note 4)

The information processing apparatus described in one of Supplementary Notes 1 to 3, in which
the output control means controls the output of the warning, based on a priority corresponding to the attention-needed state.

### (Supplementary Note 5)

The information processing apparatus described in one of Supplementary Notes 1 to 4, in which
the output control means controls the output of the warning in accordance with an amount of the attention-needed state that has been detected in one vehicle.

### (Supplementary Note 6)

The information processing apparatus described in one of Supplementary Notes 1 to 5, in which
the output control means controls the output of the warning, further based on ability information indicating an ability of the monitoring person.

### (Supplementary Note 7)

The information processing apparatus described in Supplementary Note 6, in which
the ability information includes history information indicating a situation of driving assistance that has been conducted by the monitoring person.

### (Supplementary Note 8)

The information processing apparatus described in one of Supplementary Notes 1 to 7, further includes
calculation means for calculating a characteristic of the monitoring person necessary for obtaining a predetermined monitoring quality.

### (Supplementary Note 9)

An information processing system includes:
a sensor configured to acquire vehicle situation information about a situation of a vehicle that is a monitoring target; and
an information processing apparatus,
wherein the information processing apparatus includes:
acquisition means for acquiring the vehicle situation information from the sensor;
detection means for detecting an attention-needed state that needs attention in monitoring a vehicle, based on the vehicle situation information;
estimation means for estimating a characteristic of a monitoring person monitoring the vehicle, based on an image obtained by image-capturing the monitoring person; and
output control means for controlling an output of a warning about the attention-needed state to the monitoring person, based on the characteristic that has been estimated.

### (Supplementary Note 10)

The information processing system described in Supplementary Note 9, in which
the characteristic includes information of the number of persons indicating the number of monitoring persons, and
the output control means controls the output of the warning, based on the information of the number of persons.

### (Supplementary Note 11)

An information processing method includes:
acquiring vehicle situation information about a situation of a vehicle that is a monitoring target;
detecting an attention-needed state that needs attention in monitoring a vehicle, based on the vehicle situation information;
estimating a characteristic of a monitoring person monitoring the vehicle, based on an image obtained by image-capturing the monitoring person; and
controlling an output of a warning about the attention-needed state to the monitoring person, based on the characteristic that has been estimated.

### (Supplementary Note 12)

The information processing method described in Supplementary Note 11, wherein
the characteristic includes information of the number of persons indicating the number of monitoring persons, and
in controlling the output of the warning, the output of the warning is controlled, based on the information of the number of persons.

### (Supplementary Note 13)

A non-transitory computer-readable medium storing a program for causing a computer to execute:
an acquisition process for acquiring vehicle situation information about a situation of a vehicle that is a monitoring target;
a detection process for detecting an attention-needed state that needs attention in monitoring a vehicle, based on the vehicle situation information;
an estimation process for estimating a characteristic of a monitoring person monitoring the vehicle, based on an image obtained by image-capturing the monitoring person; and
an output control process for controlling an output of a warning about the attention-needed state to the monitoring person, based on the characteristic that has been estimated.

### (Supplementary Note 14)

The non-transitory computer-readable medium described in Supplementary Note 13, in which
the characteristic includes information of the number of persons indicating the number of monitoring persons, and
in controlling the output of the warning, the output of the warning is controlled, based on the information of the number of persons.

### REFERENCE SIGNS LIST

10 INFORMATION PROCESSING APPARATUS
11 ACQUISITION UNIT
12 DETECTION UNIT
13 ESTIMATION UNIT
14 OUTPUT CONTROL UNIT
15 CALCULATION UNIT
16 INFORMATION TRANSMISSION UNIT
17 VIDEO TRANSMISSION UNIT
18 WARNING PROCESSING UNIT
19 STORAGE UNIT
20 MONITORING APPARATUS
21 DISPLAY CONTROL UNIT
22, 221, 222 DISPLAY UNIT
22a INTEGRATED MONITORING SCREEN
22b DETAILED MONITORING SCREEN
23 OPERATION UNIT
25 MONITORING PERSON CAMERA
30 IN-VEHICLE APPARATUS
31 VIDEO TRANSMISSION UNIT
32 INFORMATION TRANSMISSION UNIT
33 VEHICLE CONTROL UNIT
35 VEHICLE
40 INFRASTRUCTURE
41 VIDEO TRANSMISSION UNIT
45 INFRASTRUCTURE CAMERA
50 INFORMATION PROCESSING SYSTEM
100 INFORMATION PROCESSING APPARATUS
101 ACQUISITION UNIT
102 DETECTION UNIT
103 ESTIMATION UNIT
104 OUTPUT CONTROL UNIT
191 VEHICLE SITUATION INFORMATION
192 WARNING HISTORY INFORMATION
900 COMPUTER
902 BUS
904 PROCESSOR
906 MEMORY
908 STORAGE DEVICE
910 INPUT AND OUTPUT INTERFACE
912 NETWORK INTERFACE
A, B MONITORING PERSON
C MONITORING CENTER

What is claimed is:

1. An information processing apparatus comprising:
at least one memory storing instructions; and
at least one processor configured to execute the instructions to:
acquire vehicle situation information about a situation of a vehicle that is a monitoring target;
detect an attention-needed state that needs attention in monitoring a vehicle, based on the vehicle situation information;
estimate a characteristic of a monitoring person monitoring the vehicle, based on an image obtained by image-capturing the monitoring person; and
control an output of a warning about the attention-needed state to the monitoring person, based on the characteristic that has been estimated.

2. The information processing apparatus according to claim 1, wherein
the characteristic includes information of the number of persons indicating the number of monitoring persons, and
the at least one processor is further configured to execute the instructions to control the output of the warning, based on the information of the number of persons.

3. The information processing apparatus according to claim 1, wherein
the characteristic includes physical condition information indicating a physical condition of the monitoring person, and
the at least one processor is further configured to execute the instructions to control the output of the warning, based on the physical condition information.

4. The information processing apparatus according to claim 1, wherein the at least one processor is further configured to execute the instructions to control the output of the warning, based on a priority corresponding to the attention-needed state.

5. The information processing apparatus according to claim 1, wherein the at least one processor is further configured to execute the instructions to control the output of the warning in accordance with an amount of the attention-needed state that has been detected in one vehicle.

6. The information processing apparatus according to claim 1, wherein the at least one processor is further configured to execute the instructions to control the output of the warning, further based on ability information indicating an ability of the monitoring person.

7. The information processing apparatus according to claim 6, wherein the ability information includes history information indicating a situation of driving assistance that has been conducted by the monitoring person.

8. The information processing apparatus according to claim 1, wherein the at least one processor is further configured to execute the instructions to calculate a characteristic of the monitoring person necessary for obtaining a predetermined monitoring quality.

9. An information processing system comprising:
a sensor configured to acquire vehicle situation information about a situation of a vehicle that is a monitoring target; and
an information processing apparatus,
wherein the information processing apparatus includes:
at least one memory storing instructions; and
at least one processor configured to execute the instructions to:
acquire the vehicle situation information from the sensor;
detect an attention-needed state that needs attention in monitoring a vehicle, based on the vehicle situation information;
estimate a characteristic of a monitoring person monitoring the vehicle, based on an image obtained by image-capturing the monitoring person; and
control an output of a warning about the attention-needed state to the monitoring person, based on the characteristic that has been estimated.

10. The information processing system according to claim 9, wherein
the characteristic includes information of the number of persons indicating the number of monitoring persons, and
the at least one processor is further configured to execute the instructions to control the output of the warning, based on the information of the number of persons.

11. An information processing method comprising:
acquiring vehicle situation information about a situation of a vehicle that is a monitoring target;
detecting an attention-needed state that needs attention in monitoring a vehicle, based on the vehicle situation information;
estimating a characteristic of a monitoring person monitoring the vehicle, based on an image obtained by image-capturing the monitoring person; and
controlling an output of a warning about the attention-needed state to the monitoring person, based on the characteristic that has been estimated.

12. The information processing method according to claim 11, wherein
the characteristic includes information of the number of persons indicating the number of monitoring persons, and
in controlling the output of the warning, the output of the warning is controlled, based on the information of the number of persons.

13.-14. (canceled)
